(19) United States
(12) Patent Application Publication
(10) Pub. No.: US 2003/0002848 A1
(43) Pub. Date: Jan. 2, 2003

(54) Delivery-medium producing apparatus

(76) Inventors: Yoshiki Kawaoka, Saitama (JP); Yoshiko Shimori, Saitama (JP); Atsushi Nakamura, Tokyo (JP)

Correspondence Address: BIRCH STEWART KOLASCH & BIRCH, PO BOX 747, FALLS CHURCH, VA, 22040-0747, US

(21) Appl. No.: 09/892,769

(22) Filed: Jun. 28, 2001

(51) Int. Cl. H04N 5/76; H04N 5/225

(52) U.S. Cl. 386/46; 386/117

(57) ABSTRACT

A delivery-medium producing apparatus includes: a receiving unit for receiving a plurality of images from a plurality of users; an image keeping apparatus for keeping the images received and recorded therein by the receiving unit; and a delivery-medium recording unit for recording the images onto recording media in such a manner that each recording medium stores one or more images that were received from only one of the users.

This patent application claims priority based on a Japanese patent application, 2000-194836 filed on Jun. 28, 2000, the contents of which are incorporated herein by reference.

### BACKGROUND OF THE INVENTION

1. Field of the Invention

The present invention relates to a delivery-medium producing apparatus capable of producing a computer-readable recording medium on which at least one image is stored.

2. Description of the Related Art

According to a conventional technique, in a case of keeping an image captured by a digital camera, a user first connects the digital camera to a personal computer so as to transfer image data to the personal computer. In order to connect the digital camera to the personal computer, an interface for connecting the digital camera to the personal computer is generally required. The user has to connect the digital camera to the personal computer by using the interface every time the user wants to transfer the image data. Then, the image is recorded onto a recording medium by an operation of the personal computer by the user. In the recording operation, the user generally manages for each image a shot date when the image was captured and the like, and performs the recording operation for recording the image onto the recording medium based on the shot date and the like.

The number of the images taken by the user continues to increase as time passes. Thus, the user has to continue to perform the recording operation intermittently in an appropriate manner. However, the user has to perform all of operations for connecting the digital camera to the personal computer, transferring the image from the digital camera to the personal computer, managing the image, and recording the image onto the recording medium. Therefore, the image-storing operation is heavy burden for the user.

### SUMMARY OF THE INVENTION

Therefore, it is an object of the present invention to provide a delivery-medium producing apparatus, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, a delivery-medium producing apparatus comprises: a receiving unit operable to receive a plurality of images from a plurality of users; an image keeping apparatus operable to keep the plurality of images received and recorded therein by the receiving unit; and a delivery-medium recording unit operable to record the plurality of images onto recording media in such a manner that each of the recording media stores one or more images of the plurality of images that were received from one of the users only.

The delivery-medium producing apparatus may further comprise: another receiving unit operable to receive a negative film; and an image converting unit operable to read an image recorded onto the negative film and to convert the read image into a digital image. The digital image may be kept by the image keeping apparatus and is recorded onto one of the recording media for a corresponding user.

The delivery-medium recording unit may record the one or more images onto one of the recording media for the one of the users at predetermined intervals. Moreover, the delivery-medium recording unit may record the one or more of the plurality of images when a recording instruction from the one of the users is received.

The delivery-medium producing apparatus may further comprise a database operable to store information related to each of the plurality of images in such a manner that the information corresponds to the each of the plurality of images. The delivery-medium recording unit may record the plurality of images onto the recording media based on the information in the database. In this case, the information may include at least a user ID of the each of the plurality of images that specifies a corresponding user.

Moreover, the information may further include at least one of a date and a place the each of the plurality of images was captured. In this case, the delivery-medium recording unit records the plurality of images after classification of the images based on the at least one of the data and the place.

The delivery-medium producing apparatus may further comprise: an extra-printing-request receiving unit operable to receive an extra-printing request for an image of the plurality of images kept by the image keeping apparatus from a corresponding user; and an extra-printing processing unit operable to print the image to be extra-printed onto paper in accordance with the extra-printing request.

The extra-printing request may specify the image to be extra-printed, the number and the size of extra print.

The delivery-medium producing apparatus may further comprise a database operable to store image IDs respectively assigned to the plurality of images. In this case, the extra-printing request specifies the image to be extra-printed by specifying one of the image IDs that is assigned to the image to be extra-printed, and the extra-printing processing unit specifies the image to be extra-printed by referring to the database.

The delivery-medium producing apparatus may further comprise an extra-printing-request receiving unit operable to receive an extra-printing request for an image of the plurality of images kept by the image keeping apparatus from a corresponding user. In this case, the delivery-medium recording unit records the image to be extra-printed onto a new recording medium. The delivery-medium producing apparatus may further comprise a database operable to store image IDs respectively assigned to the images, wherein the extra-printing request specifies the image to be extra-printed by specifying one of the image IDs that is assigned to the image to be extra-printed, the delivery-medium recording unit specifies the image to be extra-printed by referring to the database and records the image thus specified onto the new recording medium.

The recording media may store the image IDs respectively assigned to the images together with the images, to help each of the users to select the image to be extra-printed.

The delivery-medium producing apparatus may further comprise: a keeping-time monitoring unit operable to monitor a keeping time for each of the plurality of images to determine whether or not the keeping time reaches an end of a predetermined keeping term, the keeping time being a time that has passed after the each of the plurality of images was recorded in the image keeping apparatus; and a keeping-time notifying unit operable to notify, when the keeping time is determined to reach the end of the predetermined keeping term, a corresponding user of the each of the plurality of images that the predetermined term expired.

The image keeping apparatus deletes one of the plurality of images for which the predetermined keeping term expired, if no user's instruction is received from the corresponding user within a predetermined waiting time period after the notification.

The delivery-medium producing apparatus may further comprise: a payment-mode receiving unit operable to receive an instruction specifying a payment mode from each of the users; and a payment processing unit operable to indirectly charge the each of the users in accordance with the specified payment mode.

According to the second aspect of the present invention, a program for use in a digital camera capable of being connected to a phone, comprises: a connection-detecting module operable to detect connection between the digital camera and the phone; a calling module operable to make the phone to call a predetermined number; and a transmitting module operable to make the digital camera transmit one or more images captured by the digital camera via the phone.

The digital camera may be connected to the phone by short-distance radio communication.

The program may further comprise a monitoring module operable to monitor the number of the one or more images captured by the digital camera to determine whether or not the number reaches a predetermined number. In this case, the transmitting module makes the digital camera transmit the one or more images when the monitored number of the one or more images reaches the predetermined number.

According to the third aspect of the present invention, a capturing device, comprises: a capturing unit operable to capture an image of an object; and a controller operable to control the capturing device and to control a communication device capable of being connected to the capturing device to communicate with an external apparatus, wherein the image is transmitted to the external apparatus via the communicating device.

The capturing device may store a program to be executed by the controller, and the capturing unit may transmit the image to the external apparatus in accordance with the program.

The capturing device may be operable to store the captured image. The controller of the capturing unit may determine whether or not the number of stored images reaches a predetermined number. The transmission may be performed in accordance with the program when the number of the images reaches the predetermined number.

The controller may determine whether or not a predetermined time period has passed after the image was captured. In this case, the transmission may be performed in accordance with the program when the predetermined time period has passed after the image was captured.

The capturing device may further comprise a unit operable to receive a user's instruction to allow the transmission to be performed manually. In this case, the transmission is performed in response to the user's instruction in accordance with the program.

The capturing device may further comprise a display operable to display the stored images to allow the user to select which image is to be transmitted to the external apparatus.

The capturing device may be formed integrally with the communicating device as a single device.

According to the fourth aspect of the present invention, a delivery-medium producing method comprise: receiving one or more images from a capturing device by means of an image receiving unit, the one or more images being images transmitted as digital data from the capturing device or images brought into an image receiving place where the image receiving unit is placed while being recorded onto a negative film; keeping the one or more images by recording the received one or more images in an image keeping apparatus; recording the one or more images onto a recording medium; and delivering the recording medium to a place specified by a user of the capturing device.

The one or more images may be transmitted via a phone capable of being connected to the capturing device via a wire or wirelessly.

The delivery-medium producing method may further comprise, when the one of more images are brought into the image receiving place while being recorded onto the negative film, converting the received one or more images into digital data after the one or more images are read from the negative film. In this case, the one or more images converted are kept in the keeping.

The delivery-medium producing method may further comprise: receiving a payment mode specified by the user; and charging the user for a required cost in accordance with the specified payment mode.

The user may be allowed to specify that the user pays the required cost in cash when the user receives the recording medium delivered to the user's specified place. Alternatively, the user may be allowed to specify at least charging via a bank or via a credit service company as the payment mode. In a case where the one or more images are images transmitted via a phone connected to the capturing device, the user maybe allowed to specify charging via a telephone company as the payment mode.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a delivery-medium producing apparatus according to an embodiment of the present invention.

FIG. 2 shows an exemplary kept image database included in the delivery-medium producing apparatus according to the embodiment of the present invention.

FIG. 3 explains an exemplary classification of kept images based on shot dates.

FIG. 4 shows payment operations by the delivery-medium producing apparatus.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

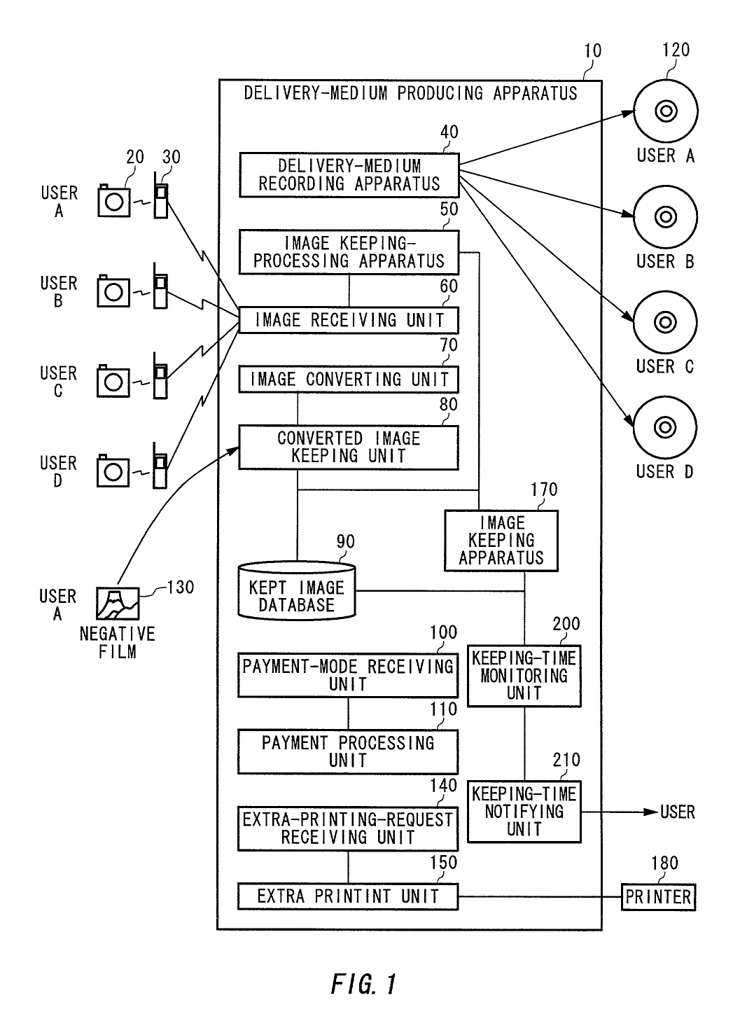

FIG. 1 illustrates a structure of a delivery-medium producing apparatus 10 according to an embodiment of the present invention. The delivery-medium producing apparatus 10 receives images from a plurality of users, and produces for each user a computer-readable recording medium such as a CD-R, MO or the like, in such a manner that the recording medium for each user stores one or more images of the user and no images of the other users. The thus produced recording medium is then delivered to a place specified by the corresponding user. The delivery-medium producing apparatus 10, a digital camera 20 and a mobile phone 30 configure a system for producing a recording medium in which an image captured by the digital camera 20 is stored.

The digital camera 20 serving as a capturing device recited in the claims includes at least a capturing unit operable to capture an image of an object and a controller operable to control at least operations of the digital camera 20 in accordance with at least one program stored in the digital camera 20. The digital camera 20 stores the image captured thereby in, for example, a memory attached to the camera. The digital camera 20 and the mobile phone 30 may communicate with each other by short-distance radio communication, such as bluetooth. The digital camera 20 may control the mobile phone 30 to communicate with the delivery-medium producing apparatus 10, thereby transmitting the image data taken by the digital camera 20 to the delivery-medium producing apparatus 10 via the mobile phone 30. In accordance with the stored program, the transmission of the image data is performed.

The transmission of the image may be performed by the digital camera 20 in accordance with the program stored in the digital camera 20 automatically or may be performed manually by the user at appropriate times. In an example, the automatic transmission of the image is performed based upon a time that has passed after the image was captured or the number of the images that were captured by the digital camera 20 and are stored in the digital camera 20. Alternatively, the automatic transmission may be performed at predetermined intervals, for example, every one month. That is, when the controller of the digital camera 20 determines that one month has passed after the previous transmission, the digital camera 20 transmits the image data stored therein. In the manual transmission, when the digital camera 20 receives the user's instruction to transmit the image(s) stored in the digital camera 20, the image(s) are transmitted to the delivery-medium producing apparatus 10.

Moreover, the digital camera 20 may transmit only selected ones of the images taken by the digital camera 20 to the delivery-medium producing apparatus 10, instead of transmitting all the images stored therein. The user may select the images to be transmitted in various manners. For example, in a case where the digital camera 20 includes a display for displaying the captured image, the digital camera 20 may display the images that were captured and stored therein so as to help the user to select the image to be transmitted. In another case where the mobile phone 30 has a display, the digital camera 20 may control the mobile phone 30 to display the image captured by the digital camera 20 in accordance with program stored in the digital camera 20, so as to help the user to select the image to be transmitted.

As the program, the digital camera 20 stores at least a program including: a connection-detecting module that makes the digital camera 20 detect connection established between the digital camera 20 and the mobile phone 30; a calling module that makes the mobile phone 30 to call a predetermined number so as to communicate with the delivery-medium producing apparatus 10; and a transmitting module that makes the digital camera 20 transmit the image data stored in the digital camera 20 via the mobile phone 30. In a case where the digital camera 20 transmits the images data when the number of the images captured and stored therein reaches a predetermined figure, the program may further include a monitoring module that makes the controller or another component of the digital camera 20 monitor the number of the images captured by the digital camera 20 so as to determine whether or not the number reaches the predetermined digure.

When the images kept in the digital camera 20 are transmitted, a phone number of the mobile phone 30 of the user or an e-mail address of the user, and the shot date each image was taken by the digital camera 20.

The digital camera 20 may obtain position information regarding a position of the digital camera 20 by using a GPS (Global Positioning System). When capturing an image, the digital camera 20 records the position thereof together. The recorded position is transmitted to the delivery-medium producing apparatus 10 together with the captured image. The recording and the transmission of the position information are performed in accordance with program stored in the digital camera 20.

Moreover, position information regarding a position of the mobile phone 30 may be obtained by providing the GPS with the mobile phone 30. In this case, the obtained position information is transmitted together with the images taken by the digital camera 20 from the mobile phone 30 to the delivery-medium producing apparatus 10. The transmission of the position information is performed in accordance with the program stored in the digital camera 20.

The delivery-medium producing apparatus 10 includes a delivery-medium recording apparatus 40, an image keeping-processing apparatus 50, an image receiving unit 60, an image converting unit 70, a converted image keeping apparatus 80, a kept image database 90, a payment-mode receiving unit 100, a payment processing unit 110, an extra-printing-request receiving unit 140, an extra printing unit 150 and an image keeping apparatus 170. The delivery-medium producing apparatus 10 further includes a controller (not shown) for controlling the above components of the delivery-medium producing apparatus 10 and stores at least one program used for controlling operations of the above components.

The image receiving unit 60 receives the images transmitted from a plurality of users via the mobile phones 30. The image receiving unit 60 also receives, for each image, image-associated information such as the e-mail address of the corresponding user, the shot date, and the shot place.

The image keeping-processing apparatus 50 writes the images received by the image receiving unit 60 onto the image keeping apparatus 170, for example, a hard disk, and also writes, for each image, the image associated information received by the image receiving unit 60 and an image ID created from the image-associated information in the kept image database 90. The image keeping-processing apparatus 50 also reads data of the image from the image keeping apparatus 170.

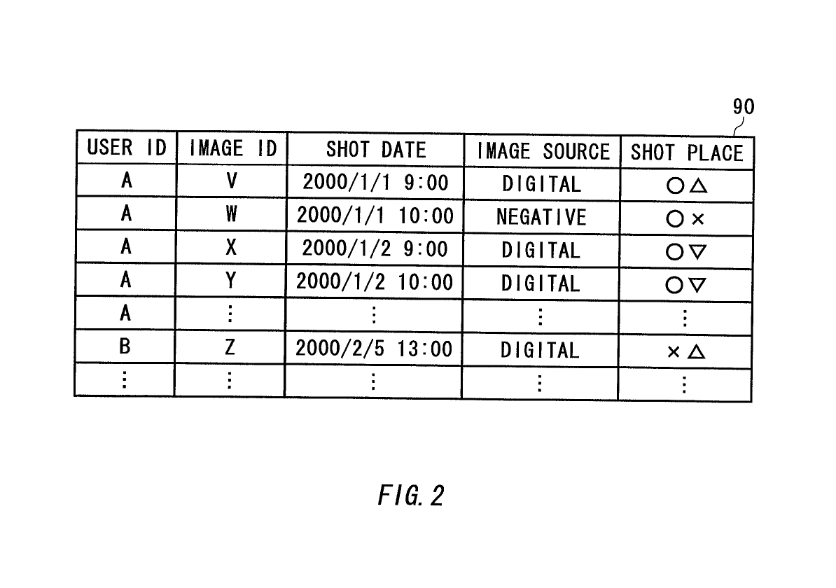

Next, the kept image database 90 is described referring to FIG. 2.

FIG. 2 shows an exemplary kept image database 90 included in the delivery-medium producing apparatus 10. In the kept image database 90, an image ID, a shot date and a shot place of the corresponding image, and a type indicating whether the corresponding image is a digital transmitted image or an image obtained from a negative film are stored for each user ID.

The image ID is created by using information unique to the mobile phone 30 that is used for transmitting the corresponding image, such as a phone number of the mobile phone 30, or information unique to the user who transmits the corresponding image, such as an e-mail address thereof, and the captured date. In a case of the image received from the user having the e-mail address is xxx@xxx.jp and the captured date is Jan. 1, 2000, 1 p.m., the image ID of xxx@xxx.jp200001011300 is created, for example. In this manner, the image ID is assigned to each of the images stored in the image keeping apparatus 170. By specifying the image ID, one of the images kept that has the specified image ID can be identified. Moreover, when the image ID is used as a file name of the image stored in the image keeping apparatus 170, it is possible to easily manage the images kept by the image keeping apparatus 170.

Returning to FIG. 1, the delivery-medium producing apparatus 10 includes the image converting unit 70 and the converted image keeping-processing unit 80. The converted image keeping-processing unit 80 receives a negative film 130 of a photograph shot by a camera that records a photographic image onto a film. The converted image keeping-processing unit 80 sends the received negative film 130 to the image converting unit 70. The image converting unit 70 converts an image recorded onto the negative film 130 into a digital image by using an image reading apparatus such as a scanner.

The negative film 130 may be brought by the user to a place which furnishes the converted image keeping-processing unit 80. The place may be a shop of a photo-development service, a convenience store or the like. A clerk may operate the converted image keeping-processing unit 80 to receive the negative film 130 brought by the user, or the user may operate the converted image keeping-processing unit 80 by oneself. Moreover, the user may bring a film roll that has not been developed yet to the development service shop or the convenience store. In this case, the negative film obtained by developing the film roll is received by the converted image keeping-processing unit 80.

The details of the image conversion to the digital image, for example, a type of image format, resolution or the like, is determined in accordance with a user's instruction. The user can input the user's instruction by means of a keyboard and/or a mouse (both not shown) of the delivery-medium producing apparatus 10. The converted image keeping-processing unit 80 also receives the shot date when the image recorded on the received negative film 130 was taken and the user ID of the user. In a case of using the same user ID as that used for the management of the images transmitted via the mobile phone 30, it is advantageous to the management of the images.

The converted image keeping-processing unit 80 writes the converted image into the image keeping apparatus 170. In this manner, the user can make the delivery-medium producing apparatus 10 produce the recording medium 120 that stores the photographic image corresponding to the negative film 130 by bringing the negative film 130 to the place where the converted image keeping-processing unit 80 is furnished. Moreover, the image keeping-processing apparatus 50 records the shot date when the image of the negative film 130 was taken onto the kept image database 90. Also for the photographic image converted from the negative film 130, the image ID is created as in a case of the image transmitted via the mobile phone 30 and recorded onto the kept image database 90.

As described above, not only the photographic image converted from the negative film 130 but also the image transmitted via the mobile phone 30 can be kept by the image keeping apparatus 170 of the delivery-medium producing apparatus 10. The information related to the kept images, for example, the shot date, is managed by referring to the kept image database 90. The image keeping apparatus 170 can accumulate the images every time a plurality of users bring the negative films 130 to the place where the converted image keeping-processing unit 80 is furnished or every time the image is transmitted via the mobile phone 30.

The delivery-medium recording apparatus 40 writes the image kept by the image keeping apparatus 170 onto the recording medium 120. The recording medium 120 is prepared for each of the user. That is, images of one user are recorded only onto the recording medium 120 prepared for that user, not onto the recording medium 120 for other users. The images kept by the image keeping apparatus 170 include the images transmitted via the mobile phone 30 and the images converted from the negative film 130, as described above. Thus, the delivery-medium recording apparatus 40 can create the recording medium 120 in which both the transmitted images and the converted images are stored. The delivery-medium recording apparatus 40 performs the recording operation, for example, at a time when a new image is received, when a predetermined time period has passed after the previous recording operation, or when the number of the stored images for each user reaches a predetermined number. In the third case, the recording operation can be performed efficiently. Moreover, the delivery-medium recording apparatus 40 may perform the recording operation when a recording instruction to record the image (s) of the user is received from the user, for example, by e-mail.

As described above, the image is recorded onto the recording medium 120 prepared for each user. In the present embodiment, the delivery-medium recording apparatus 40 refers to the user ID in the kept image database 90 to extract the images corresponding to the user ID, and writes the extracted images in the recording medium 120 prepared for the user having the user ID that is referred to.

Moreover, in the writing operation for writing the images onto the recording medium 120, the following operation may be additionally performed.

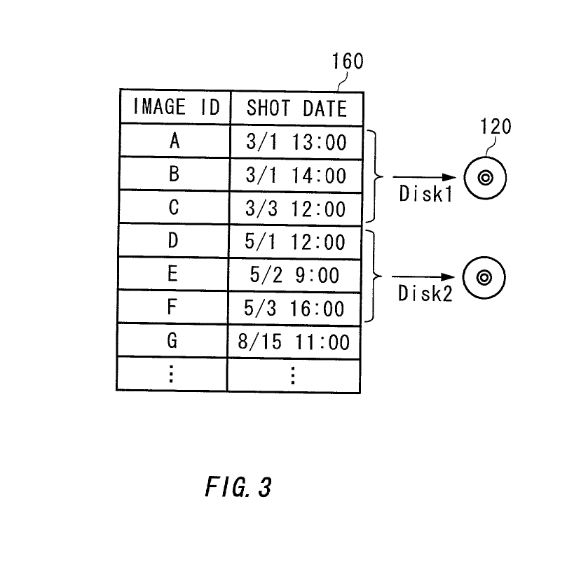

FIG. 3 explains the additional operation in which the images are classified based on the shot dates thereof. Kept-image extraction information 160 shown in FIG. 3 is in form of a table created by extracting the image IDs and the shot dates of the images kept for a certain user. As shown in FIG. 3, the shot dates are arranged in an order from the oldest one to the newest one. Based on the thus arranged shot dates, two images having shot dates that are adjacent to each other in the arranged order are recorded onto the same recording medium 120 if an interval between the shot dates of the two images (hereinafter, referred to as “shot interval”) is shorter than a predetermined period, for example, one month. If the shot interval is one month or more, the two images are stored in different recording media 120. In other words, all the shot intervals of the temporary adjacent two images that have two adjacent shot dates are shorter than the predetermined period, that is, one month in the present embodiment. When the shot interval of the two images having the shot dates that are adjacent to each other when being arranged in the order from the oldest one to the newest one, is equal to or longer than the predetermined period, a new recording medium 120 is produced. This is because the shot interval equal to or longer than the predetermined period can be interpreted as indicating that an object of the older one of the images is different from an object of the newer one. According to this classification, for example, images taken during a trip are recorded together in Disk 1 whereas images taken during another trip are recorded together in Disk 2, as shown in FIG. 3. Accordingly, the user can obtain the recording medium 120 storing the images that can be collected to have the same theme or the like are stored.

Moreover, the user may specify the images shot at places within a particular area so as to record the specified images in the same recording medium 120. In this case, the recording medium 120 storing the images classified based on the shot places can be produced.

The thus produced recording medium 120 is delivered to a place the user specified by e-mail or the like. For example, the user can specify the user's home, a convenience store or the like, as the place to which the recording medium 120 is to be delivered. In a case of the convenience store, the user goes there to receive the delivered recording medium 120. The place specified by the user may be the place where the user brought the negative film 130, such as the development service shop, the convenience store or the like.

Returning to FIG. 1, other components are described.

The payment-mode receiving unit 100 receives a payment mode specified by the user. The payment processing unit 110 charges the user for a cost required for producing the recording medium in accordance with the payment mode received by the payment-mode receiving unit 100. These components are described in detail later.

The extra-printing-request unit 140 receives a request of extra-printing from the user. More specifically, the extra-printing-request unit 140 receives at least the image ID of the image for which a copy is to be made, and the number and the size of the copy if the user wishes to receive the copy in form of a printed image on paper. The extra-printing-request unit 140 sends the extra-printing request from the user to the extra-printing processing unit 150 so as to make the extra-printing process unit 150 print the image specified by the image ID onto the paper by a printer 180 connecting thereto. Alternatively, the extra-printing-request unit 140 may send the extra-printing request to the delivery-medium recording apparatus 40 to record the requested image onto a new recording medium 120. The printed image or the newly created recording medium 120 is delivered to the place specified by the user, as described above. The place to which the extra-printed image or the new recording medium is to be delivered may be a shop, a convenience store, or a place to which the user brought the negative film. In this way, the user can obtain the copy of the image by using the user's desired medium, that is, the paper or the recording medium.

Moreover, the user can obtain a greeting card by using the above-mentioned extra-printing operation. More specifically, when the user specifies the details of the extra-printing, that is, the image ID of the image to be extra-printed and the number and the size of the copy of the image, the user requests to create the greeting card that uses the image specified by the image ID. In this case, for example, the user can easily obtain the desired number of greeting cards using the specified image and, if necessary, including a message.

Next, the manner of determining which image is to be extra-printed is described. In an example, the recording medium 120 that the user has already received may include the image ID for each image, which is linked to a predetermined web page on the Internet. In this case, the user can easily send the extra-printing-request receiving unit 140 of the delivery-medium producing apparatus 10 the extra-printing request including the image ID, the number and the size of the copy of the image if the user wishes to receive the printed copy, or the like, by clicking the image ID of the requested image. In an alternative example, the image IDs of the images kept by the image keeping apparatus 170 may be sent to the user by e-mail or the like. The e-mail may be sent to the user's computer or the mobile phone that can send/receive e-mail. In this case, the user looks up the image IDs so as to determine the image ID of the image for which the extra-printing is to be requested, and sends the extra-printing request to the extra-printing-request receiving unit 140 of the delivery-medium producing apparatus 10.

In a further alternative example, in a case where the digital camera 20 includes a display such as an LCD, thumbnail images of the images kept by the image keeping apparatus 170 may be sent to the digital camera 20 via the mobile phone 30. The digital camera 20 includes a controller (not shown) that controls the display to display the thumbnail images in accordance with at least one program stored therein, in order to help the user to select the image to be extra-printed. Thus, the user can determine the image to be extra-printed while looking up the thumbnail images on the display of the digital camera 20. When the user has determined the image to be extra-printed, the user can send the extra-printing request for that image via the mobile phone 30 by specifying the corresponding thumbnail image. Alternatively, in a case of the mobile phone 30 includes a display, the mobile phone 30 may display the thumbnail images corresponding to the images kept by the image keeping apparatus 170 to help the user to select the image to be extra-printed. Please note that the manner of determining the image to be extra-printed is not limited to the above examples.

Moreover, the delivery-medium producing apparatus 10 can produce a new recording medium 120 that stores images selected from a plurality of recording media 120. Also in this case, the user can make the delivery-medium producing apparatus 10 produce the new recording medium 120 only by sending the image IDs of the images to be extra-printed selected by the user from the plurality of recording media.

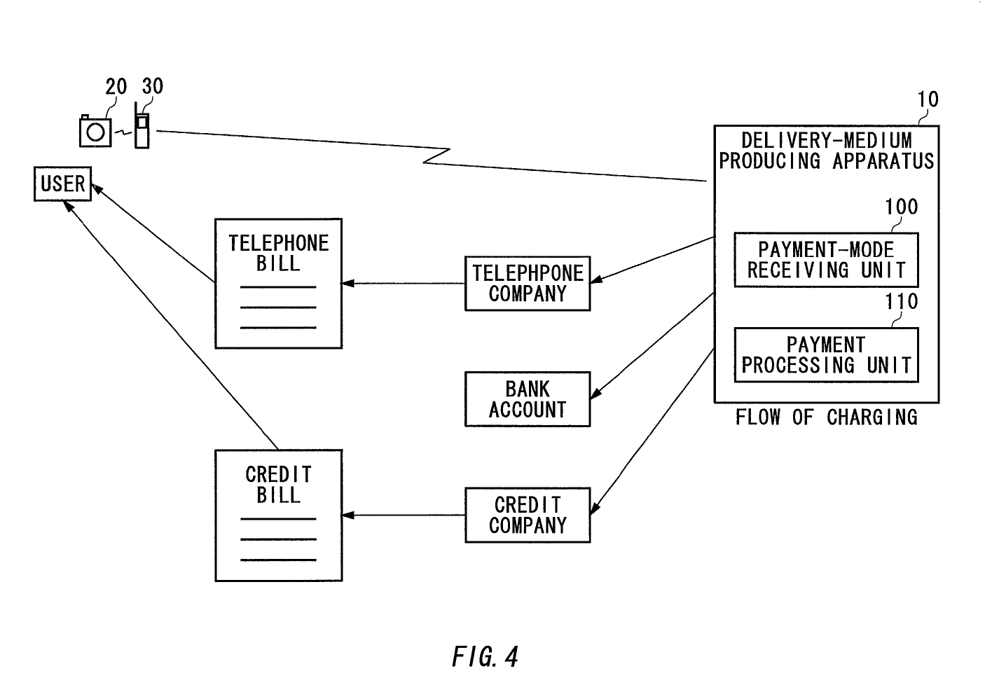

FIG. 4 shows a payment operation by the delivery-medium producing apparatus 10 according to the embodiment of the present invention. The payment-mode receiving unit 100 receives the payment mode specified by the user. The payment processing unit 110 performs the payment operation in accordance with the payment mode. As the payment mode, charging via a telephone company of the mobile phone 30, a bank or a credit service company can be specified, for example. In a case of charging via the telephone company of the mobile phone 30, the payment processing unit 110 performs an operation for adding the cost to telephone fee of the mobile phone 30. Thus, the telephone company charges the user for the telephone fee including the cost for producing the recording medium. In a case of charging via the bank, the payment processing unit 110 performs an operation for making the bank pay the cost directly from the user's account. In a case of charging via the credit service company, the payment processing unit 110 performs an operation for asking the credit service company for the cost required for producing the recording medium. The credit service company then asks the user for the cost. By the above-mentioned payment operation, the user can pay the cost without cash. Alternatively, if the user specifies the shop such as the convenience store, as the place to which the recording medium or the extra-printed photograph is to be delivered, the user may pay the producing cost in cash at the shop when the user receives the recording medium or the extra-printed photograph.

Returning to FIG. 1, the delivery-medium producing apparatus 10 may include a keeping-time monitoring unit 200 and a keeping-time notifying unit 210, if necessary. In this case, the delivery-medium producing apparatus 10 can keep the images in the image keeping apparatus 170 only a limited term. The keeping term may be determined to be one month, for example. In a case where the keeping term is limited, the keeping-time monitoring unit 200 monitors keeping time for each image, that has passed after the image was recorded in the image keeping apparatus 170, so as to determine whether or not the keeping time of the image reaches the end of a predetermined keeping term. When the keeping-time monitoring unit 200 finds the image having the keeping time that has reached the end of the keeping term, the keeping-time notifying unit 210 notifies the user who is an owner of the image that the keeping time of the image reaches the end of the predetermined term, for example, by e-mail.

If the user sends a predetermined instruction to the delivery-medium producing apparatus 10 in response to the notification within a predetermined waiting time period, the delivery-medium producing apparatus 10 may perform a predetermined operation in accordance with the user's instruction. For example, the user instructs the delivery-medium producing apparatus 10 to produce the recording medium 120 for the user, the delivery-medium producing apparatus 10 may produce the recording medium 120. In a case where the user instructs the delivery-medium producing apparatus 10 to make a copy of a certain image, the delivery-medium producing apparatus 10 makes the copy in accordance with the user's instruction. After the delivery-medium producing apparatus 10 has finished the predetermined operation or in a case where the delivery-medium producing apparatus 10 receives no instruction from the user within the predetermined waiting time period, the image for which the keeping term has expired is deleted from the image keeping apparatus 170. Thus, it is possible to prevent the excessive increase the number of the images in the image keeping apparatus 170.

The keeping term for each image has to be carefully determined considering disadvantages both to the user and the image keeping apparatus 170. For example, if the keeping term is too short, the user is urged too much to determine how to deal with the image. On the other hand, if the keeping time is too long, the burden on the image keeping apparatus 170 becomes too large.

Moreover, the image kept by the image keeping apparatus 170 of the delivery-medium producing apparatus 10 may be deleted by the user's instruction, even if the predetermined keeping term does not expire. Ina case where the digital camera 20 has a display and allows the user to delete the image stored in the digital camera 20, the user may receive the kept images or the thumbnail images corresponding to the kept images from the image keeping apparatus 170 so as to delete one of the kept images while browsing the received images presented on the display of the digital camera 20. Such a deleting operation can be realized by using a known function of the digital camera that deletes the image stored in the digital camera and transmitting the result of the deletion from the digital camera 20 to the delivery-medium producing apparatus 10 in accordance with program that is stored in and executed by the digital camera 20. Similarly, in a case where the mobile phone 30 has a display, the user may receive the kept images or the thumbnail images corresponding the kept images by the mobile phone 30, so as to determine which image is to be deleted while browsing the images by means of the mobile phone 30. The determination result is transmitted from the mobile phone 30 to the delivery-medium producing apparatus 10. The delivery-medium producing apparatus 10 deletes the image kept by the image keeping apparatus 170 based on the determination result.

In the above description, an example in which the digital camera 20 and the mobile phone 30 are separate components is described. Alternatively, the digital camera 20 and the mobile phone 30 may be formed integrally to be a single device. Also in this case, the same effects described above can be obtained. Moreover, it is not necessary that all the components of the delivery-medium producing apparatus be assembled together. For example, at least the converted image keeping-processing unit 80 for receiving the negative film 130 from the user may be provided at a shop of development service or a convenience store to which the user brings the negative film 130. In this case, the user hands the negative film 130 to a shop clerk who operates the converted image keeping-processing unit 80. Alternatively, the converted image keeping-processing unit 80 may be placed at a convenient place such as a station, as a stand-alone machine. In this case, the user can operate the converted image keeping-processing unit by oneself.

The image transmitted to the delivery-medium producing apparatus 10 is not limited to a still image. In a case of the digital camera 20 that can capture a moving picture, the captured moving picture maybe transmitted to the delivery-medium recording apparatus 10 via the mobile phone 30, thereby the moving picture is kept by the delivery-medium producing apparatus 10. In this case, it is preferable that the captured moving picture has a relatively short presentation time period. It is also preferable that the captured moving picture is transmitted after being compressed. The compression may be performed by an MPEG2 technique or an MPEG4 technique, for example.

As described above, the user can obtain the recording medium storing the image the user captured without transferring the captured image from the camera to the personal computer or the like connected to the camera and writing the transferred image onto the recording medium by oneself.

As is apparent from the above description, according to the present invention, recording media can be produced for a plurality of users, each of which stores images for the corresponding user only, so as to be provided to the users.

Although the present invention has been described by way of exemplary embodiments, it should be understood that those skilled in the art might make many changes and substitutions without departing from the spirit and the scope of the present invention which is defined only by the appended claims.

What is claimed is:

1. A delivery-medium producing apparatus comprising:
a receiving unit operable to receive a plurality of images from a plurality of users;
an image keeping apparatus operable to keep said plurality of images received and recorded therein by said receiving unit; and
a delivery-medium recording unit operable to record said plurality of images onto recording media in such a manner that each of said recording media stores one or more images of said plurality of images that were received from one of said users only.

2. A delivery-medium producing apparatus as claimed in claim 1, further comprising:
another receiving unit operable to receive a negative film; and
an image converting unit operable to read an image recorded onto said negative film and to convert said read image into a digital image,
wherein said digital image is kept by said image keeping apparatus and is recorded onto one of said recording media for a corresponding user.

3. A delivery-medium producing apparatus as claimed in claim 1, wherein said delivery-medium recording unit records said one or more images onto one of said recording media for said one of said users at predetermined intervals.

4. A delivery-medium producing apparatus as claimed in claim 1, wherein said delivery-medium recording unit records said one or more of said plurality of images when a recording instruction from said one of said users is received.

5. A delivery-medium producing apparatus as claimed in claim 1, further comprising a database operable to store information related to each of said plurality of images in such a manner that said information corresponds to said each of said plurality of images, wherein
said delivery-medium recording unit records said plurality of images onto said recording media based on said information in said database.

6. A delivery-medium producing apparatus as claimed in claim 5, wherein said information includes at least a user ID of said each of said plurality of images that specifies a corresponding user.

7. A delivery-medium producing apparatus as claimed in claim 6, wherein said information further includes at least one of a date and a place said each of said plurality of images was captured, and
said delivery-medium recording unit records said plurality of images after classification of said images based on said at least one of said data and said place.

8. A delivery-medium producing apparatus as claimed in claim 1, further comprising:
an extra-printing-request receiving unit operable to receive an extra-printing request for an image of said plurality of images kept by said image keeping apparatus from a corresponding user; and
an extra-printing processing unit operable to print said image to be extra-printed onto paper in accordance with said extra-printing request.

9. A delivery-medium producing apparatus as claimed in claim 8, wherein said extra-printing request specifies said image to be extra-printed, the number and the size of extra print.

10. A delivery-medium producing apparatus as claimed in claim 8, further comprising a database operable to store image IDs respectively assigned to said plurality of images, wherein
said extra-printing request specifies said image to be extra-printed by specifying one of said image IDs that is assigned to said image to be extra-printed, and
said extra-printing processing unit specifies said image to be extra-printed by referring to said database.

11. A delivery-medium producing apparatus as claimed in claim 10, wherein said recording media stores said image IDs respectively assigned to said images together with said images, to help each of said users to select said image to be extra-printed.

12. A delivery-medium producing apparatus as claimed in claim 1, further comprising an extra-printing-request receiving unit operable to receive an extra-printing request for an image of said plurality of images kept by said image keeping apparatus from a corresponding user, wherein
said delivery-medium recording unit records said image to be extra-printed onto a new recording medium.

13. A delivery-medium producing apparatus as claimed in claim 12, further comprising a database operable to store image IDs respectively assigned to said images, wherein
said extra-printing request specifies said image to be extra-printed by specifying one of said image IDs that is assigned to said image to be extra-printed,
said delivery-medium recording unit specifies said image to be extra-printed by referring to said database and records said image thus specified onto said new recording medium.

14. A delivery-medium producing apparatus as claimed in claim 13, wherein said recording media stores said image IDs respectively assigned to said images together with said images, to help each of said users to select said image to be extra-printed.

15. A delivery-medium producing apparatus as claimed in claim 1, further comprising:
a keeping-time monitoring unit operable to monitor a keeping time for each of said plurality of images to determine whether or not said keeping time reaches an end of a predetermined keeping term, said keeping time being a time that has passed after said each of said plurality of images was recorded in said image keeping apparatus; and
a keeping-time notifying unit operable to notify, when said keeping time is determined to reach said end of said predetermined keeping term, a corresponding user of said each of said plurality of images that said predetermined term expired.

16. A delivery-medium producing apparatus as claimed in claim 15, wherein said image keeping apparatus deletes one of said plurality of images for which said predetermined keeping term expired, if no user's instruction is received from said corresponding user within a predetermined waiting time period after the notification.

17. A delivery-medium producing apparatus as claimed in claim 1, further comprising:
a payment-mode receiving unit operable to receive an instruction specifying a payment mode from each of said users; and
a payment processing unit operable to indirectly charge said each of said users in accordance with said specified payment mode.

18. A program for use in a digital camera capable of being connected to a phone, comprising:
a connection-detecting module operable to detect connection between said digital camera and said phone;
a calling module operable to make said phone to call a predetermined number; and
a transmitting module operable to make said digital camera transmit one or more images captured by said digital camera via said phone.

19. A program as claimed in claim 18, wherein said digital camera is connected to said phone by short-distance radio communication.

20. A program as claimed in claim 18, further comprising a monitoring module operable to monitor the number of said one or more images captured by said digital camera to determine whether or not said number reaches a predetermined number, wherein
said transmitting module makes said digital camera transmit said one or more images when said monitored number of said one or more images reaches said predetermined number.

21. A capturing device, comprising:
a capturing unit operable to capture an image of an object; and
a controller operable to control said capturing device and to control a communication device capable of being connected to said capturing device to communicate with an external apparatus, wherein
said image is transmitted to said external apparatus via said communicating device.

22. A capturing device as claimed in claim 21, wherein said capturing device stores a program to be executed by said controller, and
said capturing unit transmits said image to said external apparatus in accordance with said program.

23. A capturing device as claimed in claim 22, wherein said capturing device is operable to store said captured image,
said controller of said capturing unit determines whether or not the number of stored images reaches a predetermined number, and
said transmission is performed in accordance with said program when said number of said images reaches said predetermined number.

24. A capturing device as claimed in claim 22, wherein said controller determines whether or not a predetermined time period has passed after said image was captured, and
said transmission is performed in accordance with said program when said predetermined time period has passed after said image was captured.

25. A capturing device as claimed in claim 22, further comprising a unit operable to receive a user's instruction to allow said transmission to be performed manually, wherein
said transmission is performed in response to said user's instruction in accordance with said program.

26. A capturing device as claimed in claim 25, further comprising a display operable to display said stored images to allow said user to select which image is to be transmitted to said external apparatus.

27. A capturing device as claimed in claim 21, wherein said communicating device is formed integrally with said capturing device as a single device.

28. A delivery-medium producing method comprising:
receiving one or more images from a capturing device by means of an image receiving unit, said one or more images being images transmitted as digital data from said capturing device or images brought into an image receiving place where said image receiving unit is placed while being recorded onto a negative film;
keeping said one or more images by recording said received one or more images in an image keeping apparatus;
recording said one or more images onto a recording medium; and
delivering said recording medium to a place specified by a user of said capturing device.

29. A delivery-medium producing method as claimed in claim 28, wherein said one or more images are transmitted via a phone capable of being connected to said capturing device via a wire or wirelessly.

30. A delivery-medium producing method as claimed in claim 28, further comprising, when said one of more images are brought into said image receiving place while being recorded onto said negative film, converting said received one or more images into digital data after said one or more images are read from said negative film, wherein
said one or more images converted are kept in said keeping.

31. A delivery-medium producing method as claimed in claim 28, further comprising:
receiving a payment mode specified by said user; and
charging said user for a required cost in accordance with said specified payment mode.

32. A delivery-medium producing method as claimed in claim 31, wherein said user is allowed to specify that said user pays said required cost in cash when said user receives said recording medium delivered to said user's specified place.

33. A delivery-medium producing method as claimed in claim 31, wherein said user is allowed to specify at least charging via a bank or via a credit service company as said payment mode.

34. A delivery-medium producing method as claimed in claim 33, wherein, said one or more images are images transmitted via a phone connected to said capturing device, said user is allowed to specify charging via a telephone company as said payment mode.
